(19) United States
(12) Patent Application Publication
(10) Pub. No.: US 2026/0149713 A1
(43) Pub. Date: May 28, 2026

(54) BEHAVIOR BASED ACCESS CONTROL USING CLOUD ENGINE IN INDUSTRIAL AUTOMATION SYSTEMS

(71) Applicants: Schneider Electric IT Corporation, Foxborough, MA (US); Schneider Electric USA, Inc., Boston, MA (US); Schneider Electric Systems USA, Inc., Foxborough, MA (US)

(72) Inventors: Vignesan SELVARAJ, Andover, MA (US); Qing Sheng HAN, Andover, MA (US); Abhishek Babu PEECHARA, Foxborough, MA (US)

(21) Appl. No.: 18/963,065

(22) Filed: Nov. 27, 2024

(51) Int. Cl. H04L 9/40

(52) U.S. Cl. CPC H04L 63/10; H04L 63/0823; H04L 63/1433; H04L 2463/082

(57) ABSTRACT

A method and system of performing behavior based access control in an industrial automation system. A first device requests access to a second device within the industrial automation system. The second device requests a certificate from the first device. The first device transmits a certificate, which contains a device risk level. A risk assessment engine determines the device risk score by evaluating device security information. After validating the certificate, by a certificate authority processor, the device risk level is compared to a predetermined risk threshold. In response to the device risk level exceeding the risk threshold, a multi-factor authentication request is transmitted to the first device. Upon completion of the multi-factor authentication, the first device is granted access and connects to the second device. In response to the device risk level falling below the predetermined threshold, the first device is granted access and a connection opens.

### BACKGROUND

Industrial automation systems require security measures to ensure that devices connecting within the system are authentic and secure. Conventional methods of securing systems include user log-in, device passwords, or pin codes. In addition to an initial security method, many systems implement multi-factor authentication. Multi-factor authentication requires either a user or device to perform an additional validation to ensure that the user or device connection is authentic. Industrial automation systems implement many different forms of multi-factor authentication such as one-time passwords, pin codes, push notification or the like.

Multi-factor authentication provides a more secure system, but implements a higher burden on users or devices within the system. A rigid implementation of multi-factor authentication delays configuration and connection within the industrial automation system, and can add additional load on devices that have a low security risk. Devices within the industrial automation system have varying degrees of risk based on their behavior. Some devices have limited network access and only perform specific operations while connecting to other devices and thus pose a low risk of vulnerability. Other devices may operate critical equipment within the environment, accept many request from other devices, and connect to the external internet, presenting a high security risk. In conventional methods of access control, both devices are treated the same. As a result, if the system implements universal multi-factor authentication the low risk device must perform the operation for every connection despite the low security risk presented by the device. Meanwhile implementing a system without mandatory multi-factor authentication leaves the highest risk equipment vulnerable as connection requests can be accepted without proper validation of the connecting device.

To authenticate a device, industrial automation systems may rely on a certificate authority. A certificate authority provides validation that a requesting client device is authentic because the authority has validated the client device by generating a certificate for the client device. During a connection request the client device can then present the certificate to another device for validation. The certificate provides an extra layer of security and device validation, however, the certificate on its own provides no basis for determining the risk presented by a client device. Commonly certificate authorities implement a standard such as X.509, an International Telecommunication Union standard for public key certificates, or EMV, for electronic payment methods.

### SUMMARY

Aspects of the present disclosure disclose a system for behavior-based authentication in an industrial automation system. The system generates a certificate which includes a device risk score based upon device security information that includes behavior and status of the client device. During a connection request, an evaluation of the risk score determines whether to require a multi-factor authentication of the client device.

In an aspect, a system for behavior-based access control between a plurality of devices in an industrial automation system includes first and second devices of the industrial automation system. The first device is configured to generate an access request to connect to the second device and the second device is configured to generate a validation request in response to the access request. The system also includes a certificate validation processor communicatively coupled to the first and second devices of the industrial automation system. The certificate validation processor receives and is responsive to a certificate from the first device in response to the validation request from the second device. The certificate includes a device risk level associated with the first device. The system further includes a memory storing computer-executable instructions that, when executed by the certificate validation processor, configure the certificate validation processor for receiving the certificate from the first device, validating the certificate, retrieving a device risk level associated with the first device from the certificate, assessing the device risk level. In addition, the executed instructions configure the certificate validation processor for, transmitting, in response to the device risk level exceeding a predetermined risk threshold, a multi-factor authentication request to the first device before granting the access request to connect the first device to the second device.

In another aspect, a method of behavior-based access control in an industrial automation system includes transmitting, by a first device of the industrial automation system, an access request to a second device of the industrial automation system and requesting, by the second device, a certificate from the first device. The method also includes sending, by the second device, a certificate validation request to a certificate validation processor, wherein the certificate validation request comprises the certificate. The method further includes validating, by the certificate validation processor, the certificate, retrieving a device risk level associated with the first device from the certificate, and transmitting, in response to the device risk level of the client certificate exceeding a predetermined risk threshold, a multi-factor authentication request to the first device before granting the access request to connect the first device to the second device.

In yet another aspect, a method of generating a certificate for a client device includes receiving, by a certificate authority generator, a certificate request from a client device. The method also includes requesting, by the certificate authority generator, client device security information from the client device and transmitting the client device security information to a cloud server. The method further includes executing, by the cloud server, a cloud-based risk assessment engine. Executing the cloud-based risk assessment engine includes receiving the device security information, generating a client device risk score based upon the client device security information, and sending the client device risk score to the certificate authority generator. The method also includes generating a client device certificate. The client device certificate comprises the client device risk score and a signature, wherein the signature is generated through encryption based upon a public key of the client device and a private key of the certificate authority.

Other objects and features of the present invention will be in part apparent and in part pointed out herein.

### BRIEF DESCRIPTION OF THE DRAWINGS

FIG. 1 illustrates a system for behavior-based access in an industrial automation system according to an embodiment.

FIG. 2 is a flow diagram illustrating a process of generating a client device certificate using a cloud-based risk assessment engine according to an embodiment.

FIG. 3 is a flow diagram illustrating a process of authenticating an access request in a behavior-based access control system according to an embodiment.

FIG. 4 is a swim lane diagram illustrating authenticating a connection request on a device with a low risk score according to an embodiment.

FIG. 5 is a swim lane diagram illustrating authenticating a connection request on a device with a high risk score, and thus requiring multi-factor authentication according to an embodiment.

Corresponding reference characters indicate corresponding parts throughout the drawings.

### DETAILED DESCRIPTION

The features and other details of the concepts, systems, and techniques sought to be protected herein will now be more particularly described. It will be understood that any specific embodiments described herein are shown by way of illustration and not as limitations of the disclosure and the concepts described herein. Features of the subject matter described herein can be employed in various embodiments without departing from the scope of the concepts sought to be protected.

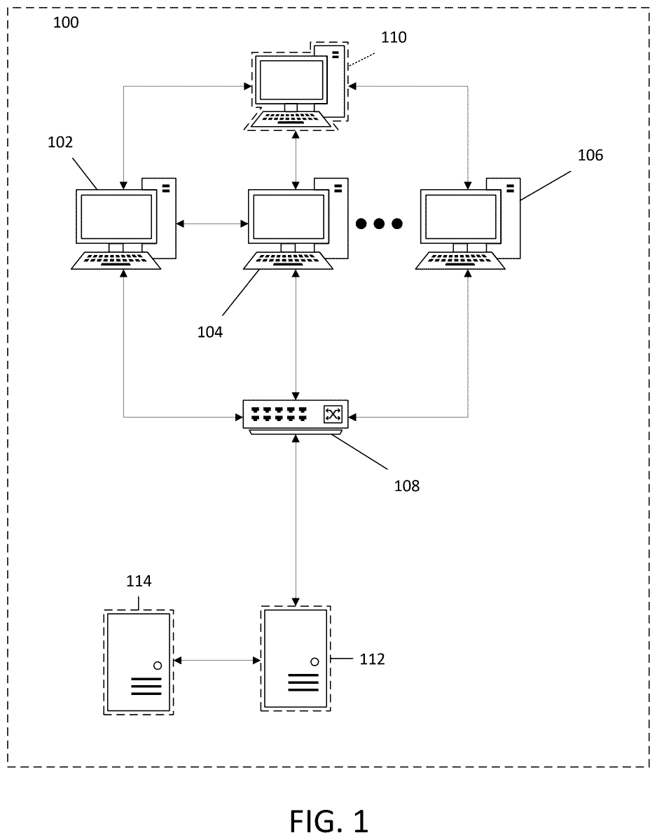

Referring to the figures and description below, a system 100 for behavior-based access control in an industrial automation system is disclosed. FIG. 1 is a block diagram illustrating the system 100. In some embodiments, multiple client devices are configured to connect to the network of an industrial automation system. In one embodiment, shown in FIG. 1, a first client device 102, a second client device 104, and other client devices 106 communicate and connect through a local network. In other embodiments, the client devices 102, 104, 106 connect through a global network such as the internet. In some embodiments, network communication between the devices may be through a hard line such as Ethernet or other network link. In other embodiments, devices may communicate wirelessly through Wi-Fi or Bluetooth. In an embodiment, client devices 102, 104, 106 may be any component of the industrial automation process such as controllers, processors, sensors, or other types of robotics. In another embodiment, client devices 102, 104, 106 comprise operator devices such as a smart phone, tablet, or laptop.

The certificate authority generator 108 handles and responds to certificate requests from client devices 102, 104, 106. The certificate authority generator 108 ensures secure connections and that connections between industrial automation system devices can be trusted. In some embodiments, the certificate authority generator 108 operates within the industrial automation network. In other embodiments, the certificate authority generator 108 operates external to the industrial automation network and connects to client devices 102, 104, 106 through the internet. In some embodiments, the certificate authority generator 108 is configured to handle both access request to a client device and certificate requests from a client device. During a certificate request, described further below, the certificate authority generator 108 generates a certificate for the client device 102, 104, 106 to use in future access requests. In some embodiments, the certificate authority generator 108 complies with a certificate standard such as the X.509 standard.

The certificate validation processor 110 handles validation requests between devices 102, 104, 106 within the industrial automation system. During an access requests, further described below, the certificate validation processor 110 validates a request and determines whether access should be granted or if the connecting devices needs to take further action. In some embodiments, the certificate validation processor 110 processes validation requests within the client devices 102, 104, 106 themselves as a component of the client device. In other embodiments, the certificate validation processor 110 resides on the same physical hardware as the certificate authority generator 108. In still other embodiments, the certificate validation processor 110 operates independent of the other components of the system.

To facilitate generation of a client device certificate, the certificate authority generator 108 connects with a risk assessment engine 112. In some embodiments, the risk assessment engine 112 is cloud-based and operates on remote servers in the cloud connected to the certificate authority generator 108 through the internet. In other embodiments, the risk assessment engine 112 operates within the information technology infrastructure of the industrial automation system. In yet another embodiment, the risk assessment engine 112 directly operates within the certificate authority generator 108. In some embodiments, the certificate authority generator 108 operates within the same servers or information technology infrastructure as the risk assessment engine 112. The risk assessment engine 112 generates risk scores for client devices 102, 104, 106, described further below, to enable behavior-based risk assessment. The risk score is then transmitted back to the certificate authority generator 108 to incorporate within the client certificate.

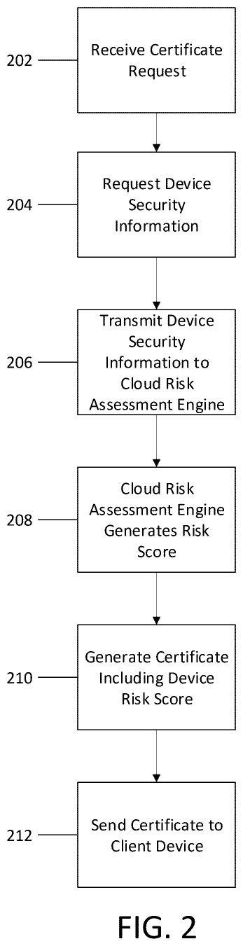

FIG. 2 shows an embodiment of generating a client device certificate. At 202, a client device submits a certificate request to the certificate authority generator 108. In some embodiments, the certificate request includes information such as a client device public key or other information based upon certificate requirements. Then at 204, certificate authority generator 108 requests device security information from the client device. The device security information enables generation of certificates responsive to device behavior and status. In various embodiments, the certificate authority generator 108 requests different aspects of device security information. The device security information is collected by the client device itself, then the certificate authority generator 108 transmits the information on to risk assessment engine 112 at step 206.

Examples of device security information include but are not limited to: a device genuineness status that indicates whether a hardware device itself has been validated; previous statuses of certificate registration; whether the device has the most up-to-date firmware and other security patches; the device firmware and/or software versions along with known vulnerabilities within; the feature set of the client device; and a security baseline associated with a certain client device. Further, the device security information incorporates other aspects of the device within the industrial automation system such as: the network the device connects to, such as whether the devices only accesses an internal network or an external network such as the internet at-large; a list of other devices to which the client device connects; how often the client device opens connections to other devices; how often other devices connect to the client device; how many ports are typically active on the client device; the operation time of the client device, such as whether the device operates primarily during normal working hours or remains accessible 24/7; and the physical location of the device. In some embodiments, the device security information also includes whether the requesting client device operates as a server and thus has other client connections or only acts as a client itself and a status of whether the device represents critical equipment to the industrial automation system.

In step 208, risk assessment engine 112 generates a risk score for the client device based on the security information. In some embodiments, risk assessment engine 112 procedurally calculates a risk score for the client device 102, 104, and/or 106. For example, risk assessment engine 112 starts with a baseline risk score based on the type of client device. The engine 112 then increases or decreases the risk score based on evaluation of the various device security information. For example, if the device 102, 104, and/or 106 has not been updated with the latest firmware or other security patches, the risk score increases, however if the device has the latest versions the risk score decreases or remains the same. Similarly, if the device 102, 104, and/or 106 has high activity, connects to many devices, or keeps many ports active at a given time, the risk score further increases. The final risk score calculate reflects the general risk for the device given the most recent device security information. In some embodiments, risk assessment engine 112 calculates a risk score based on connecting user information such as administrative status and other permissions rather than the device security information.

In some embodiments, the risk assessment engine 112 generates the risk score through an artificial intelligence (AI) engine 114, executed by, for example, the same computing device executing risk assessment engine 112. In another embodiment, a separate computing device executes the AI engine 114. In some embodiments, the AI engine 114 trains by weighting historical client device information. In one embodiment, the historical client device information includes information about which devices have connected to the network, how long connections remain open, software and/or firmware version history for client devices 102, 104, 106, and client device network information. In some embodiments, the AI engine 114 trains further by weighting historical industrial automation system security information. In some embodiments, the historical industrial automation security information comprises previous security events, devices incorporated or decommissioned within the system, equipment operation times, and critical infrastructure. After training the AI engine 114, the engine retrains through testing on new client device information and/or industrial automation system security events. As a result, the AI engine 114 continues to remain up-to-date based on security information within the system and security information outside the system such as device firmware and software information. In some embodiments, the risk engine 112 generates the risk score through the AI engine 114. In other embodiments, the risk engine generates the risk score by weighting a score generated by the AI engine 114 and a risk score generated through procedural process described above.

After calculation of the risk score, at step 210, the engine 112 transmits the risk score to the certificate authority generator 108, which then generates a client device certificate incorporating the risk score. In some embodiments, the certificate authority generator 108 generates an encrypted signature based upon a public key of the client device, which serves as a client signature, and the private key of the certificate authority generator 108. The certificate authority generator 108 stores the risk score within the certificate. In some embodiments, the certificate includes other information such as an expiration date, or other validity limitations.

In some embodiments, the certificate authority generator 108 operates and generates the certificate in accordance with a standard such as, X.509.

Then at step 212, the certificate authority generator 108 transmits the client device certificate to the client devices 102, 104, 106. Each client device 102, 104, 106 then stores its certificate for use in connection requests to other devices 102, 104, 106 within the industrial automation system. In some embodiments, the client device refreshes the client device certificate on a regular cadence, such as every few hours or every few days. With a regular refreshing cadence, the system evolves with device behavior and ensures that each authentication follows an appropriate procedure given the device's security risk and behavior.

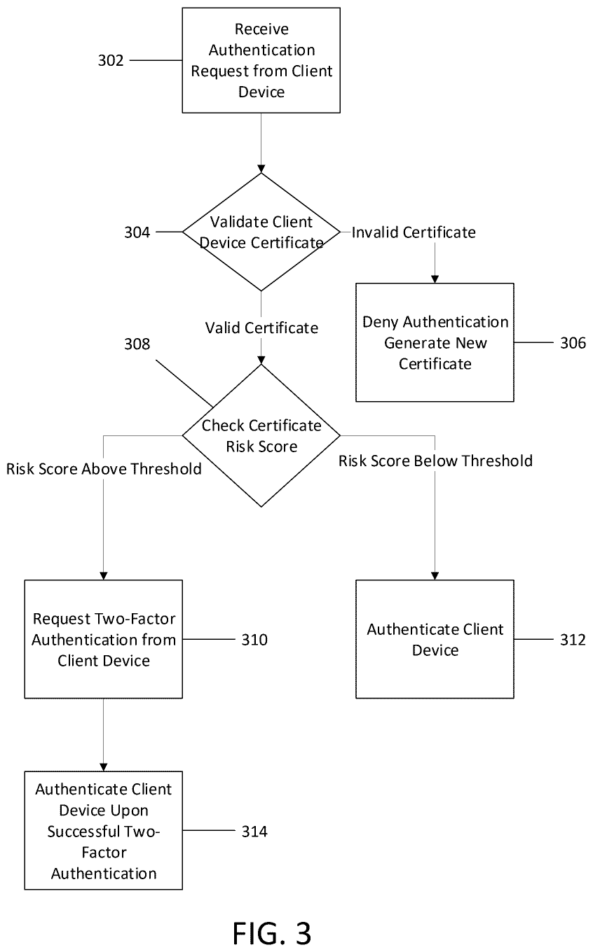

Referring now to FIG. 3, the flow diagram illustrates an example access request. In some embodiments, first client device 102 requests to connect to second client device 104 at step 302. In some embodiments, the request from the first client device 102 includes a previously generated certificate, described above, to authenticate the request. In other embodiments, the second client device 104, after only receiving a connection request, requests a certificate from the first client device 102. In some embodiments, the first client device 102 then transmits a previously generated certificate. In other embodiments, the first client device 102 then requests and generates a new certificate from the certificate authority generator 108, which is then submitted to the second client device 104.

Then at step 304, after receiving the access request and the certificate from first client device 102, the second client device 104 transmits the client certificate to a certificate validation processor 110 for validation. In some embodiments, the certificate validation processor 110 operates within the second client device 104 and thus the second device validates the certificate locally. In other embodiments, the certificate validation processor 110 operates as a component of the certificate authority generator 108. The certificate validation processor 110 validates the certificate, which contains a risk level, further described above. In an embodiment, initial validation of the certificate involves evaluating the certificate authority signature within the certificate. In some embodiments, initial validation of the certificate comprises evaluating the expiration and/or validity dates for the certificate.

At step 306, if the certificate validation processor 110 finds the certificate invalid, further action must be taken. In some embodiments, if the certificate validation processor 110 finds the certificate invalid, the certificate validation processor 110 transmits a rejection back to the second client device 104 to deny the connection. In an embodiment, if the certificate validation processor 110 finds the request exceeds the expiration date of the certificate, the certificate validation processor 110 requests the first client device 104 to renew the certificate. In some embodiments, renewing the certificate includes regenerating the device risk level for the client device based upon newer device security information. By implementing a shorter expiration date for a certificate, the system more readily adapts to changes due to a client device's status. As a result, the client device connects more or less easily based on updating device security factors and behavior. However, in other embodiments, a longer expiration timer for a certificate limits frequent collection of device security information from a given client device and the subsequent calculation of the client device's risk level.

If the certificate validation processor 110 finds the certificate initially valid, the certificate validation processor 110 then evaluates a status based upon the device risk level at step 308. In determining the status, the certificate validation processor 110 compares the device risk level to a predetermined risk threshold. In some embodiments, an operator of the industrial automation system configures the predetermined risk threshold for the entire system by setting a value. In other embodiments, the operator configures the predetermined risk threshold by setting an individual value for each client device. In yet another embodiment, the certificate validation processor 110 procedurally generates a predetermined risk threshold based on various information similar to the procedural risk score generation. In yet another embodiment, the certificate validation processor 110 generates a predetermined risk threshold either for individual devices or the system as a whole through AI engine, described above.

The predetermined risk threshold provides several benefits. In a new environment, the threshold can be set to a low or zero value ensuring that all devices initially perform multi-factor authentication before connecting. The threshold can then be adjusted as the system operates to better reflect the security threat to the environment. Further, during a security threat event, the threshold can be reduced again to require full multi-factor authentication until the threat has passed. A single system wide threshold allows easy configuration of the system and enforces matching security requirements for all devices operating within the system. However, individual device configuration allows a more tailored experience for devices within the system wherein a given device may need a higher threshold to ensure faster operation within the system. Setting a lower threshold for an individual device ensures that a particular device always performs multi-factor authentication regardless of the status of other devices within the system.

Describing step 310, if the risk level rises above the predetermined risk threshold, the certificate validation processor 110 transmits a multi-factor authentication request back to the second client device 104. However, if the risk level falls below the threshold, the certificate validation processor 110 authorizes the connection as shown in step 312. Then the second device 104 opens a link with the first device 102 without requiring a multi-factor authentication. By evaluating a risk score for a client device, a lower risk device connects to other devices more easily. Rather than requiring multi-factor authentication for every access request, the system only requires such requests when the client device presents a high risk or the system presents a low threshold due to the vulnerability or criticality of the equipment.

In one embodiment, after receiving a multi-factor authentication request from the certificate validation processor 110, the second client device 104 forwards the request to the first client device 102. In some embodiments, the multi-factor authentication request comprises a one-time password that must be entered on the first client device. In other embodiments, the multi-factor authentication request may comprise a pin code, push notification or other similar methods. Upon successful completion of the multi-factor authentication, the second device 104 grants access to the first device 102 and opens a connection between the two devices at step 314.

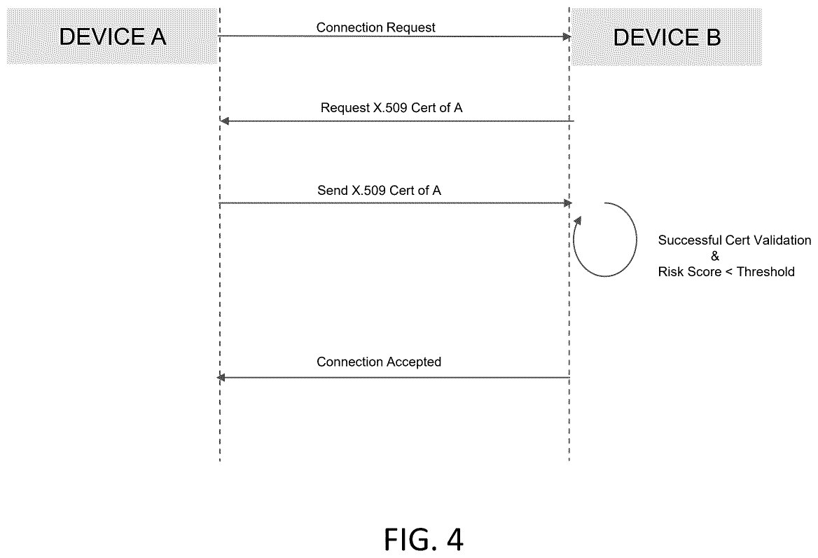

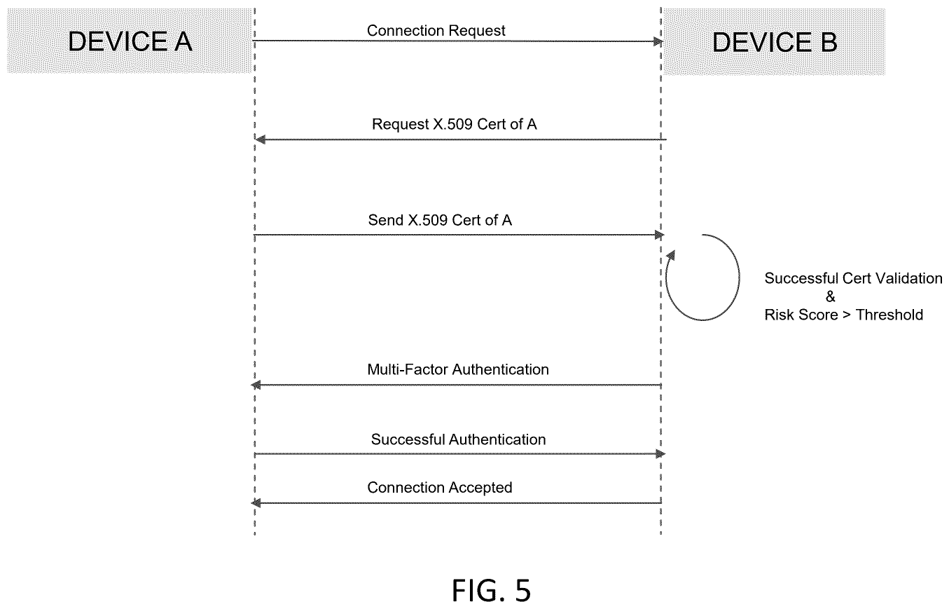

FIGS. 4 and 5 present swim lane charts of two embodiments of the access request and authentication process. In both embodiments, Device A (e.g., client device 102) makes a connection request to Device B (e.g., client device 104). Device B then requests Device A's X.509 certificate. Device A then returns the certificate to Device B. In FIG. 4, in one embodiment, Device B performs validation on the certificate itself with the certificate validation processor operating locally on Device B. Still referring to FIG. 4, the risk score of Device A falls below the predetermined threshold and thus Device B accepts the connection from Device A. Now referring to FIG. 5, in one embodiment, after receiving the certificate from Device A, Device B validates the certificate. However, during validation Device B finds that the risk score exceeds the predetermined threshold. As a result, Device B then sends a multi-factor authentication request back to Device A. Upon successful completion of the multi-factor authentication request and transmission back to Device B, Device B accepts the connection from Device A.

Embodiments of the present disclosure may comprise a special purpose computer including a variety of computer hardware, as described in greater detail herein.

For purposes of illustration, programs and other executable program components may be shown as discrete blocks. It is recognized, however, that such programs and components reside at various times in different storage components of a computing device, and are executed by a data processor(s) of the device.

Although described in connection with an example computing system environment, embodiments of the aspects of the invention are operational with other special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the example operating environment. Examples of computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the present disclosure may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the present disclosure may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments may be implemented with processor-executable instructions. The processor-executable instructions may be organized into one or more processor-executable components or modules on a tangible processor readable storage medium. Also, embodiments may be implemented with any number and organization of such components or modules. For example, aspects of the present disclosure are not limited to the specific processor-executable instructions or the specific components or modules illustrated in the figures and described herein. Other embodiments may include different processor-executable instructions or components having more or less functionality than illustrated and described herein.

The order of execution or performance of the operations in accordance with aspects of the present disclosure illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of the invention.

When introducing elements of the invention or embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components.

Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates embodiments by way of example and not by way of limitation. This description enables one skilled in the art to make and use aspects of the invention, and describes several embodiments, adaptations, variations, alternatives and uses of the aspects of the invention, including what is presently believed to be the best mode of carrying out the aspects of the invention. Additionally, it is to be understood that the aspects of the invention are not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the invention defined in the appended claims. As various changes could be made in the above constructions and methods without departing from the scope of the invention, it is intended that all matter contained in the above description and shown in the accompanying drawings shall be interpreted as illustrative and not in a limiting sense.

In view of the above, it will be seen that several advantages of the aspects of the invention are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

1. A system for behavior-based access control between a plurality of devices in an industrial automation system, the system comprising:
a first device of the industrial automation system;
a second device of the industrial automation system, the first device configured to generate an access request to connect to the second device and the second device configured to generate a validation request in response to the access request;
a certificate validation processor communicatively coupled to the first and second devices of the industrial automation system, the certificate validation processor receiving and responsive to a certificate from the first device in response to the validation request from the second device, the certificate including a device risk level associated with the first device; and
a memory coupled to the certificate validation processor and storing computer-executable instructions that, when executed by the certificate validation processor, configure the certificate validation processor for:
receiving the certificate from the first device;
validating the certificate;
retrieving a device risk level associated with the first device from the certificate;
assessing the device risk level; and
transmitting, in response to the device risk level exceeding a predetermined risk threshold, a multi-factor authentication request to the first device before granting the access request to connect the first device to the second device.

2. The system of claim 1, further comprising:
a certificate authority generator communicatively coupled to the certificate validation authority processor, the first device, and the second device, the certificate authority generator receiving and responsive to a certificate request from the first device;
a risk assessment engine communicatively coupled to the certificate authority generator, the risk assessment engine configured for generating, in response to a receiving a risk assessment request, the device risk level based upon device security information associated with the first device.

3. The system of claim 2, further comprising a memory coupled to the certificate authority generator and storing computer-executable instructions that, when executed by the certificate authority generator, configure the certificate authority generator for:
sending the risk assessment request to the risk assessment engine in response to receiving the certificate, the risk assessment request comprising the device security information associated with the first device; and
receiving a device risk level from the risk assessment engine in response to the risk assessment request.

4. The system of claim 3, wherein the computer-executable instructions stored in the memory coupled to the certificate authority generator, when executed by the certificate authority generator, further configure the certificate authority generator for:
requesting, before sending the risk assessment request, device security information from the first device.

5. The system of claim 2, wherein the device security information comprises one or more of a device genuineness status, a device security baseline, device location information, device connection information, a number of open ports, times of operation for the first device, and security vulnerability information.

6. The system of claim 5, wherein the risk assessment engine executes an artificial intelligence (AI) model trained on historical device security information for generating the device risk level and modeling the device risk level based upon the device security information associated with the first device.

7. The system of claim 1, wherein the device certificate further comprises an expiration date.

8. The system of claim 1, wherein the computer-executable instructions stored in the memory, when executed by the certificate validation processor, further configure the certificate validation processor for receiving, before assessing the device risk level, an input defining the predetermined risk threshold.

9. The system of claim 8, wherein the input to define the risk threshold is device-specific and configures the risk threshold for the first device individually.

10. The system of claim 1, wherein the computer-executable instructions stored in the memory, when executed by the certificate validation processor, further configure the certificate validation processor for authorizing the second device to accept the access request and connect to the first device after validating the device certificate and in response to the risk level being below the risk threshold.

11. A method of behavior-based access control in an industrial automation system, the method comprising:
transmitting, by a first device of the industrial automation system, an access request to a second device of the industrial automation system;
requesting, by the second device, a certificate from the first device;
sending, by the second device, a certificate validation request to a certificate validation processor, wherein the certificate validation request comprises the certificate;
validating, by the certificate validation processor, the certificate;
retrieving a device risk level associated with the first device from the certificate; and
transmitting, in response to the device risk level of the client certificate exceeding a predetermined risk threshold, a multi-factor authentication request to the first device before granting the access request to connect the first device to the second device.

12. The method of claim 11, wherein the method further comprises:
transmitting, before transmitting an access request, by the first device, a certificate request to a certificate authority generator;
requesting, by the certificate authority generator, client device security information from the first device;
sending, from the certificate authority generator, the client device security information to a risk assessment processor;
generating the device risk level for the client device based on the client device security information; and
transmitting, by the certificate authority generator, the certificate comprising the device risk level to the first device.

13. The method of claim 12, the method further comprising:
training, before transmitting a certificate request by the first device, an artificial intelligence (AI) risk assessment engine based on a plurality of historic device security information;
generating, by the artificial intelligence risk assessment engine, a predicted device risk level; and
wherein generating the device risk level is further based on the predicted device risk level.

14. The method of claim 12, wherein the client device security information comprises one or more of a device genuineness status, a device security baseline, device location information, device connection information, a number of open ports, times of operation for the first device, and security vulnerability information.

15. The method of claim 11, wherein the method further comprises:
generating, before transmitting an access request, the predetermined risk threshold based on a plurality of historic device security information.

16. The method of claim 11, wherein the multi-factor authentication comprises a one-time password authentication.

17. A method of generating a certificate for a client device, the method comprising:
receiving, by a certificate authority generator, a certificate request from a client device;
requesting, by the certificate authority generator, client device security information from the client device;
transmitting the client device security information to a cloud server;
executing, by the cloud server, a cloud-based risk assessment engine, wherein executing the cloud-based risk assessment engine comprises:
receiving the device security information;
generating a client device risk score based upon the device security information; and
sending the client device risk score to the certificate authority generator; and
generating a client device certificate wherein the client device certificate comprises the client device risk score and a signature, wherein the signature is generated through encryption based upon a public key of the client device and a private key of the certificate authority.

18. The method of claim 17, the method further comprising:
validating the client device certificate, in response to an access request from the client device to a connected device wherein the connected device performs validation through a certificate validation processor communicatively coupled to the connected device;
retrieving, by the certificate validation processor, the client device risk score from the certificate;
transmitting, to the connected device, in response to a predetermined risk threshold exceeding the client device risk score, authorization for the connection; and
opening a connection between the connected device and the client device.

19. The method of claim 17, wherein the client device certificate further comprises a certificate expiration date.

20. The method of claim 17, wherein the client device security information comprises at least one of a device genuineness status, a device security baseline, device location information, device connection information, a number of open ports, times of operation for the first device, and security vulnerability information.

21. The method of claim 17, wherein executing the cloud-based risk assessment engine further comprises training, before receiving the device security information, an artificial intelligence model based on historical device security information; and wherein generating the client device risk score is further based on the artificial intelligence model.

22. The method of claim 17, wherein generating the client device certificate further comprises generating, in accordance with X.509 standards, the client device certificate.
